(19) United States
(12) Patent Application Publication
(10) Pub. No.: US 2008/0071599 A1
(43) Pub. Date: Mar. 20, 2008

(54) METHOD AND SYSTEM FOR MULTI CALENDAR MERGING

(75) Inventor: Naveenkumar V. Muguda, Cary, NC (US)

Correspondence Address: CANTOR COLBURN LLP - IBM RSW, 20 Church Street, 22nd Floor, Hartford, CT, 06103, US

(73) Assignee: International Business Machines Corporation, Armonk, NY (US)

(21) Appl. No.: 11/532,944

(22) Filed: Sep. 19, 2006

(51) Int. Cl. G06F 9/46

(52) U.S. Cl. 705/9

(57) ABSTRACT

A method of merging a schedule entry between a composite calendar allowed to include all of a plurality of schedule entries pertaining to a user, and a component calendar including a portion of the plurality of schedule entries is disclosed. The method includes establishing and applying a priority policy based upon criteria of the schedule entry to define a priority level of the schedule entry within the composite calendar, establishing a first, second, and third policy to define the merging of the schedule entry, respectively, from the composite calendar to the component calendar, from the component calendar to the composite calendar, and from the component calendar to another component calendar, and merging the schedule entry calendar in accordance with the appropriate established policy. In response to determining that a conflict exists between any two schedule entries, merging into the composite calendar the schedule entry having a higher priority level.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to electronic schedules, and particularly to the merging of multiple electronic schedules.

2. Description of Background

Electronic schedule programs, also herein referred to as calendars, are used to track events. Often, multiple calendars are used to track the schedule of a user from different perspectives, such as that of a workplace calendar and a personal calendar, for example, and may be shared with others. The current state of the art provides a capability to merge information from multiple sources, but is limited to merging all of the information from multiple sources together. This often leads to an overload of information, or providing to others additional, unintended information. Accordingly, the state of the art will be advanced by a multi-calendar merging arrangement that overcomes these drawbacks.

### SUMMARY OF THE INVENTION

The shortcomings of the prior art are overcome and additional advantages are provided through the provision of a multi-calendar merging system and method to filter schedule entries according to a rule-based policy.

An embodiment of the invention includes a method of merging a schedule entry between a composite calendar allowed to include all of a plurality of schedule entries pertaining to a user, and a component calendar including a portion of the plurality of schedule entries. The method includes establishing and applying a priority policy based upon criteria of the schedule entry to define a priority level of the schedule entry within the composite calendar. Further, establishing a first, second, and third policy to define the merging of the schedule entry, respectively, from the composite calendar to the component calendar, from the component calendar to the composite calendar, and, from the component calendar to another component calendar. In response to determining that the schedule entry is to be merged from the composite calendar to the component calendar, merging the schedule entry from the composite calendar to the component calendar in accordance with the first policy. In response to determining that the schedule entry is to be merged from the component calendar to the composite calendar, merging the schedule entry from the component calendar to the composite calendar in accordance with the established second policy. In response to determining that the schedule entry is to be merged from the component calendar to the other component calendar, merging the schedule entry from the component calendar to the other component calendar in accordance with the established third policy. In response to determining that a conflict exists between any two schedule entries relating to the composite calendar, the component calendar, or the other component calendar, comparing the priority levels of the two schedule entries in conflict, and merging into the composite calendar the respective schedule entry having a higher priority level.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that will allow a user to merge schedule entries between a composite calendar and at least one component calendar according to rule-based policies. The rule-based policies are designed to provide transfer of the schedule entries in accordance with user-specified rules. This will therefore reduce required user intervention, and enhance the efficiency and usability of the composite calendar and the component calendars.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a schedule merging system in accordance with an embodiment of the invention.

FIG. 2 illustrates one example of a flowchart of a method to merge schedule entries in accordance with an embodiment of the invention.

The detailed description explains the preferred embodiments of the invention, together with advantages and features, by way of example with reference to the drawings.

### DETAILED DESCRIPTION OF THE INVENTION

Calendars are used to track events, appointments, and meetings of interest from various sources. Information relevant to an individual or group is not always found in one calendar. Also, not all of the information found in a calendar is relevant. Using calendar data exchange standards, such as iCalendar, created by the Internet Engineering Task Force (IETF), it is possible to merge calendars, but there is still a need for associating filtering criteria during the merge operation.

In an embodiment, various component calendars, created by and for others, are merged into a composite, or master, calendar of a user. In an embodiment, the composite calendar is merged with separate workplace, personal, and client calendars, for example. This allows the user to share, and control, the access and content of various portions of his schedule, as provided by the component calendars, with various others.

In an illustrative exemplary embodiment, the schedule of a basketball league may be made available for merge, or incorporation, into the user's composite calendar. However, it will be appreciated that the user may not be interested in all of the games scheduled for the basketball league. In an exemplary embodiment of the invention, only the games meeting user-specified criteria would be merged into the composite calendar of the user from the component calendar made available by the basketball league for merging. In an exemplary embodiment, only the games corresponding to user-specified teams, schedule preferences, and channel broadcast criteria will be merged with the composite calendar of the user.

In an embodiment, the user can define rules to control the merging of information from one component calendar to another. In an exemplary embodiment, schedule entries are merged from the composite calendar to the component calendar, as well as from the component calendar to the composite calendar. In another illustrative exemplary embodiment, all entries from the workplace component calendar that may be shared with workplace associates, are first merged to the composite calendar, and subsequently merged to the personal component calendar that may be shared with friends. In an embodiment, the details regarding schedule entries of the workplace component calendar are removed, and the entries are shown as “at work” within the personal component calendar. In another embodiment, rules are defined to assign priorities to schedule entries and automatically manage conflicts from overlapping calendars. For example, schedule entries merged from a Dentist appointment component calendar can be specified to have the highest priority above any conflicting meetings.

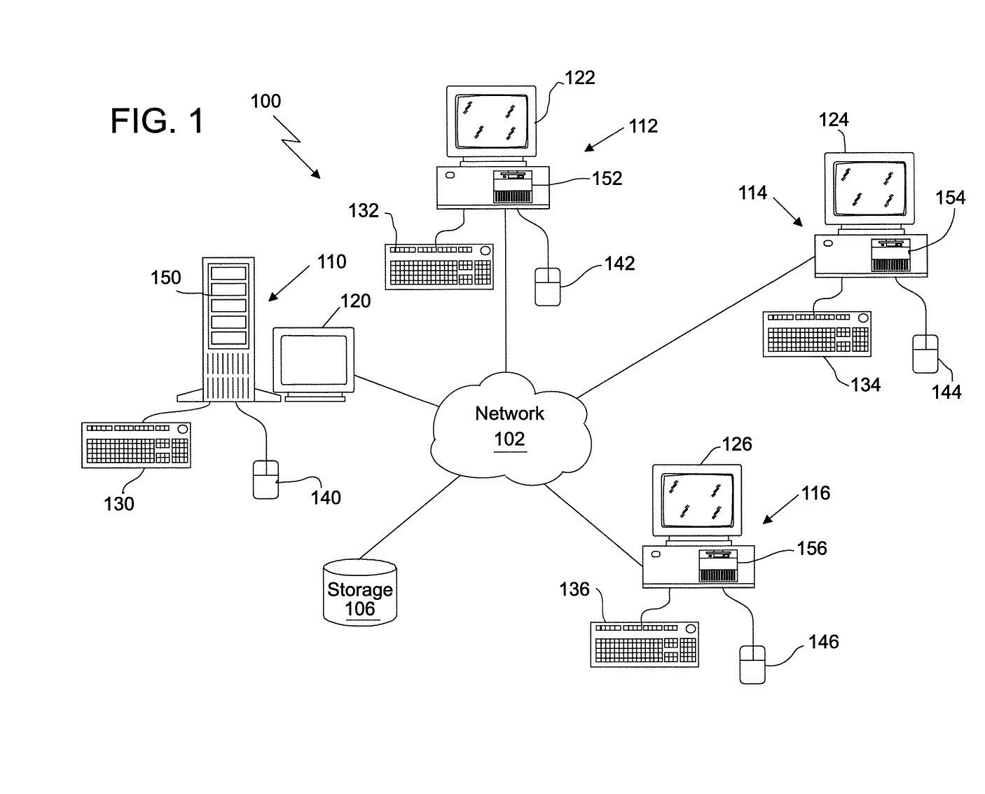

With reference now to the figures, and in particular, with reference to FIG. 1, a pictorial representation of a schedule merging system 100 in which the present invention may be implemented is depicted. The schedule merging system 100 is configured to merge a schedule entry between a composite calendar allowed to comprise all of a plurality of schedule entries pertaining to a user, and a component calendar comprising a portion of the plurality of schedule entries.

The schedule merging system 100 includes a network 102, which is the medium used to provide communication links between various devices and computers connected together within the schedule merging system 100. The network 102 may include permanent connections, such as wire or fiber optic cables, temporary connections made through telephone connections, or wireless connections, for example.

In the depicted example, computers 110-116 are each connected to the network 102 and are configured to be in signal communication via the network 102. Computer 110 is a schedule server capable to host a plurality of composite calendars for a plurality of users. Computers 112-116 are schedule clients configured to be responsive to a request of any one of the users to access, modify, or share all or part of the composite schedule. Schedule clients 112-116 are also configured to make available to the user component calendars created by others, and to make available to others, as designated by the user, the appropriate component calendars. The schedule clients 112-116 may be, for example, personal computers or network computers. The schedule merging system 100 may include additional computers, such as servers, and clients, for example, and other devices not shown. In an embodiment, the schedule merging is client based, that is, the user is capable to access, and define, the rules to merge calendars via any of the schedule clients 112-116. Furthermore, it will be appreciated that a particular computer may serve the role of either the client, to access a calendar provided by a different computer (acting as the server), or may be a server, to provide access to the calendar to the different computer.

In an example, the schedule merging system 100 includes the Internet, with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, the schedule merging system 100 may also be implemented via a number of different types of networks 102, such as an Intranet or a local area network, for example.

Each schedule server 110 and schedule client 112-116 within the schedule merging system 100 may have a program storage device 150-156 to store schedule, system, data, and application files. Output devices, such as CRT display screens 120-126, are configured to display a calendar window, for example, and input devices, such as keyboards 130-136, and mice 140-146, for example, are configured to enter text to prepare schedule entries, for example. In an embodiment, each schedule client 112-116 is configured to communicate with the others via the network 102, to share and merge calendar schedule entries.

While an embodiment of the invention has been described to use keyboards 130-136 and mice 140-146 as input devices, and CRT display screens 120-126 as output devices to provide electronic communication, it will be appreciated that the scope of the invention is not so limited, and that the invention also applies to schedule merging systems 100 that may utilize alternate input and output devices, such as writing tablets, voice recognition, and audio speakers, for example.

While an embodiment of the invention has been depicted with four computers linked together via a common network for the purposes of electronic communication, it will be appreciated that the scope of the invention is not so limited, and that the invention will also apply to other arrangements of computers connected together, such as many more computers linked together, via one network of computers in signal communication with another network of computers that may located as far apart as to be on different continents, for example.

FIG. 1 is intended as an example, and not as an architectural limitation for the processes of the present invention.

In an embodiment, at least one of schedule clients 112-116 are configured to establish and apply a priority rule-based policy based upon criteria of the schedule entry to define a priority level of the schedule entry within the composite calendar. The priority level will be used in response to a schedule conflict between schedule entries (from possibly, different component calendars). That is, in response to determining that a conflict exists between any two schedule entries relating to the composite calendar, the component calendar, or another component calendar, at least one of the schedule clients 112-116 are configured to compare the established priority levels and to merge into the composite calendar the schedule entry having the higher priority level. It will be appreciated that, as may be frequent practice, and will be discussed further below, the higher priority level is that to which is assigned the lower numerical value, that is, an entry with the priority level value of 1 is to be considered the highest priority level. In an embodiment, at least one of the schedule clients 112-116 are configured assign to all schedule entries merged from a specific component calendar to the composite calendar a specific priority level, such as all entries of a component calendar provided by a dentist will be assigned a priority level of 1 within the composite calendar to indicate that any possibly conflicting schedule entries will be subordinate to the schedule entries within the component calendar provided by the dentist, for example. Continuing the example, in an embodiment, the schedule entry of the component calendar provided by the dentist will be merged into the composite calendar above any other schedule entries that may be provided by other component calendars.

While an embodiment of the invention has been described wherein all schedule entries of a particular component calendar are assigned a specific priority level, it will be appreciated that the scope of the invention is not so limited, and the invention will also apply to schedule merging systems 100 that are capable to assign priority levels based upon other rule-based policies, such as assigning a specific priority level to all entries within a specific component calendar at a particular day of the week, time of day, or involving specific participants, for example.

In an embodiment, if there is a conflict between two schedule entries having the same priority level, or a conflict with at least one schedule entry absent a defined priority level, at least one of the schedule clients 112-116 are configured to notify the user of the schedule entry conflict prior to the merging of the schedule entries.

In an embodiment, the user can examine and determine if the schedule entries contained within the composite calendar are appropriate to be merged from the composite calendar to the at least one component calendar. In response to determining that the entries are appropriate to be merged from the composite calendar to the at least one component calendar, the user can identify to the system 100 the component calendar to be merged with the composite calendar. In an exemplary embodiment, the user can specify that the system 100 will subsequently, automatically, merge schedule entries from the composite calendar to the component calendar without further involvement on the part of the user. For example, subsequent to the user determination that schedule entries from the composite calendar will be merged into the personal component calendar, the system 100 can automatically merge schedule entries from the composite calendar to the personal component calendar, subject to any one of a set of rule-based polices described further below.

In an embodiment, at least one of the schedule clients 112-116 are configured to allow the user to establish a first rule-based policy to define the merging of the schedule entry from the composite calendar to the component calendar. In an embodiment, at least one of the schedule clients 112-116 are configured to merge the schedule entry from the composite calendar to the component calendar in accordance with the established first rule-based policy. One example of a rule within the rule-based policy is to merge from the composite component calendar to the component calendar only schedule entries that occur subsequent to a specific time of the day, for example.

While an embodiment of the invention has been described having a rule-based policy wherein the merging of schedule entries from the composite calendar to the component calendar occurs in response to the schedule entries being subsequent to a specific time of the day, it will be appreciated that the scope of the invention is not so limited, and that the invention will also apply to schedule merging systems 100 that use additional rule-based policies to automate the merging of the schedule entries. Examples of additional rule-based policies include, but are not limited to, merging all entries from the workplace component calendar to the composite calendar and establishing a priority level of 2 to all entries that occur within a specified timeframe, not merging entries from the work component calendar to the composite calendar that include specific content, such as a specific participant or location, and removing details from specific entries as they are merged, such as replacing meeting information detail with the text “work meeting” in response to a schedule entry being merged from the composite calendar to the personal component calendar, for example.

In an embodiment, the user can examine and determine if the schedule entries contained within the component calendar are appropriate to be merged to the composite calendar. In response to determining that the entries are appropriate to be merged from the component calendar to the composite calendar, the user can identify to the system 100 the component calendar from which the entries are to be merged with the composite calendar. In an exemplary embodiment, the user can specify that the system 100 will subsequently, automatically, merge schedule entries from the component calendar to the composite calendar without further involvement on the part of the user. For example, subsequent to the user determination that schedule entries from the workplace component calendar will be merged into the composite calendar, the system 100 can automatically merge schedule entries from the workplace component calendar to the composite calendar, subject to the rule-based policies, as will be described further below.

In an embodiment, at least one the schedule clients 112-116 are configured to allow the user to establish a second rule-based policy to define the merging of the schedule entries from the component calendar to the composite calendar. In an embodiment, at least one of the schedule clients 112-116 are configured to merge the entries from the component calendar to the composite calendar in accordance with the established second rule-based policy.

In an embodiment, the user can examine and determine if the schedule entries contained within the component calendar are appropriate to be merged to another component calendar. In response to determining that the entries are appropriate to be merged from the component calendar to the other component calendar, the user can identify to the system 100 the component calendar from which the entries are to be merged with the other component calendar. In an exemplary embodiment, the user can specify that the system 100 will subsequently, automatically merge schedule entries from the component calendar to the other component calendar without further involvement on the part of the user. For example, subsequent to the user determination that schedule entries from a client component calendar will be merged into the workplace component calendar, the system 100 can automatically merge schedule entries from the workplace component calendar to the composite calendar, subject to the rule-based policies.

In an embodiment, at least one of the schedule clients 112-116 are configured to allow the user to establish a third rule-based policy to define the merging of the schedule entries from the component calendar to the other component calendar. In an embodiment, at least one of the schedule clients 112-116 are configured to merge the entries from the component calendar to the other component calendar in accordance with the established third rule-based policy.

In an embodiment, at least one of the schedule clients 112-116 are configured to establish at least one of the first, and third rule-based policy to modify the schedule entry subsequent to the schedule entry being merged to a specific component calendar. For example, as described above, the user may desire that others with whom he may share his personal component calendar are made aware of the existence of a professional engagement, but also desire that the details of the professional engagement are not disclosed. Accordingly, the schedule merging system 100 will be configured to allow the user to define the third rule-based policy to modify, by renaming for example, the appropriate schedule entries that are merged from the workplace component calendar to the personal component calendar to indicate the presence of the professional engagement, such as “Busy” for example. While an embodiment of the invention has been described configured to modify the schedule entry by renaming the schedule entry, it will be appreciated that the scope of the invention is not so limited, and that the invention will also apply to schedule merging systems that will modify the schedule entry in other manners, such as to change the schedule entry time, any notes included within the schedule entry, and any information related to participants associated with the schedule entry, for example.

In an embodiment, at least one of the schedule clients 112-116 are configured to establish at least one of the first, second, and third rule-based policies via specification of a schedule entry time criteria and to define a rule-based merge policy to merge the schedule entry that meets the specified schedule entry time criteria. Continuing the example presented above, it will be appreciated that the user may desire to specify that only professional engagements that occur between particular times will be merged with the personal component calendar. It will be further appreciated that such rule-based policies may be combined, or nested, together. An exemplary nested first rule-based policy might be defined to rename and merge from the composite calendar to the personal component calendar all schedule entries that occur between 9 AM and 5 PM on a weekday.

While an embodiment of the invention has been described having a first rule-based policy to rename and merge schedule entries from the composite calendar to the component calendar that occur between 9 AM and 5 PM on a weekday, it will be appreciated that the scope of the invention is not so limited, and that the invention will also apply to schedule merging systems that may have a second or third rule based policy that may be established to rename and merge schedule entries from the component calendar to the composite calendar, and from the component calendar to another component calendar, respectively. Further, it will be appreciated that the invention will also apply schedule merging systems that may have rule-based policies that may have varying schedule entry time criteria and varying schedule entry day criteria, such as 9 AM to 5 PM on Monday, Tuesday, and Wednesday, and 7 AM to 3 PM on Thursday, Saturday, and Sunday, for example.

In an embodiment, at least one of the schedule clients 112-116 are configured to establish at least one of the first, second, and third rule-based policy via specification of a schedule entry date criteria and definition of the rule-based merge policies to merge the schedule entry that meets the specified schedule entry date criteria. Continuing the example presented above, it will be appreciated that the user may desire to specify that only workplace engagements that occur between particular dates will be merged with the personal component calendar. It will be further appreciated that such rule-based policies may be combined, or nested, together. An exemplary nested first rule-based policy might be defined to rename and merge from the composite calendar to the personal component calendar all schedule entries that occur between 9 AM and 5 PM on a weekday between March 1st and April 15th, for example.

In an embodiment, at least one of the schedule clients 112-116 are configured to establish at least one of the first, second, and third rule-based policy via specification of a schedule entry content criteria and definition of the rule-based merge policies to merge the schedule entry that meets the specified schedule entry content criteria. Continuing the example presented above, it will be appreciated that the user may desire to specify that only workplace engagements that include specific content will be merged with the personal component calendar. For example, the user may desire that only schedule entries designated as “meetings” will be merged with the personal component calendar. It will be appreciated that the content of the schedule entries may be further defined, such as to merge schedule entries that are designated as “meetings” that also include “Mr. Johnson”. It will be further appreciated that such rule-based policies may be combined, or nested, together. An exemplary nested first rule-based policy might be defined to rename and merge from the composite calendar to the personal component calendar all schedule entries that occur between 9 AM and 5 PM on a weekday between March 1st and April 15th, that are designated as “meetings” that also include “Mr. Johnson” for example.

It will be appreciated that in an embodiment, at least one of the schedule clients 112-116 are configured to specify at least two of the schedule entry time criteria, the schedule entry date criteria, and the schedule entry content criteria and to define the rule-based policy to merge the schedule entry that meets the at least two specified schedule entry criteria. Further, in an embodiment, at least one of the schedule clients 112-116 are configured to merge the schedule entry from the composite calendar to the component calendar comprising a single component calendar and to merge the schedule entry from the component calendar to the composite calendar including a single component calendar.

As a further illustrative example, it will be appreciated that component calendars may be created and made available for public use, such as a component calendar created by a basketball league to allow fans to merge scheduled games into their composite calendar and any component calendars as deemed appropriate. It will be further appreciated that in an embodiment, the user may specify a rule-based policy to merge only those games that will be played on specific evenings, with specific scheduled start times, and involving specific teams into his composite calendar and personal component calendar. Subsequent to the specification of the appropriate rule-based policy, the schedule merging system 100 will automatically merge the appropriate games into the appropriate calendars in accordance with the policy defined by the rules, without further user involvement. Further, it will be appreciated that if a basketball game is attempted to be merged with the composite calendar at a time that has been previously scheduled, and that possesses a higher priority level, such as a Dentist appointment, for example, the conflicting basketball game will not be merged.

In an embodiment, the policies that include the rules for merging the schedule entries will be based upon the iCalendar data exchange standard. In an embodiment, the rules can be enforced by a rule engine that parses the calendar entries and the rules. In an embodiment, an exemplary rule to assign all entries from the workplace component calendar occurring between 9 AM and 5 PM a priority level of 2 will have the form “work_calendar.entry,time[9 AM-5 PM]=2”. In an embodiment, an exemplary rule to assign all entries from the dentist component calendar a priority level of 1 will have the form “dentist_calendar.entry.*=1”. In an embodiment, an exemplary rule to copy all the entries from the workplace component calendar to the personal component calendar and rename them as “Busy” will have the form “copy(work_calendar.entry.*, personal_calendar, BUSY)”. In an embodiment, an exemplary rule to copy all entries from a client component calendar to the workplace component calendar, and not rename them will have the form “copy(client_calendar.entry.*, work_calendar, AS-IS)”.

While an embodiment has been described using the iCalendar data exchange standard created by the Internet Engineering Task Force (IETF), to define the rules used by the policies, it will be appreciated that the scope of the invention is not so limited, and that the invention will also apply to calendar merging systems 100 that may utilize other data exchange standards having alternate rule formats to define and establish rule-based policies, for example.

In view of the foregoing, the calendar merging system 100 performs the method of merging the schedule entry between the composite calendar, allowed to include all of the plurality of schedule entries pertaining to the user, and the component calendar, including only a portion of the plurality of schedule entries.

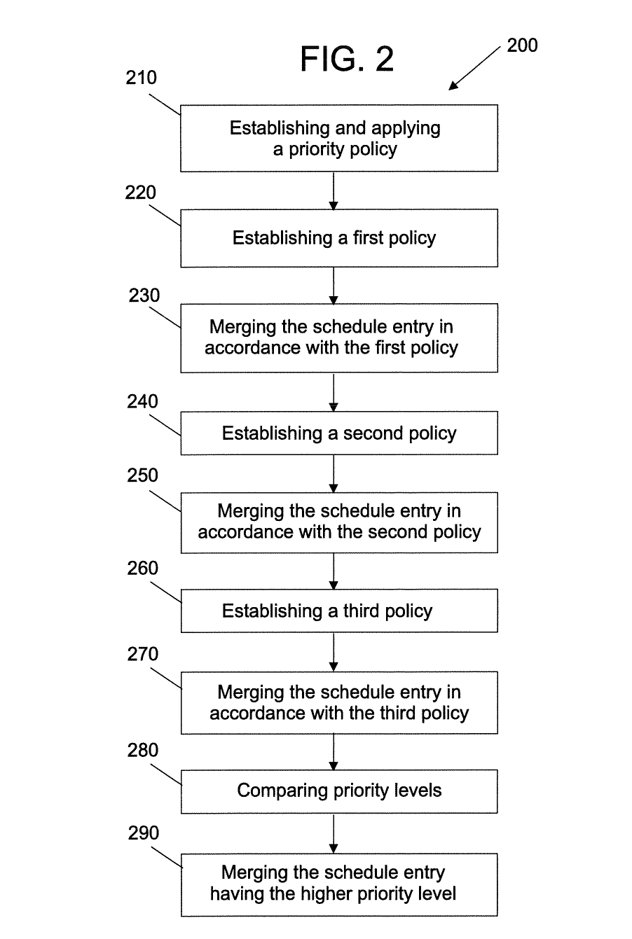

Referring now to FIG. 2, a flowchart 200 of an exemplary embodiment of the method to merge the schedule entry is depicted. It will be appreciated that the flowchart 200 includes each of the first, second, and third policies that define, respectively, merging the schedule entry from the composite calendar to the component calendar, merging the schedule entry from the component calendar to the composite calendar, and merging the schedule entry from the component calendar to the other component calendar. The method begins with establishing 210 and applying the priority policy based upon criteria of the schedule entry to define the priority level of the schedule entry, and establishing 220 the first policy to define the merging of the schedule entry from the composite calendar to the component calendar. In an embodiment, the establishing the priority policy includes assigning the specific priority level to all schedule entries merged from the specific component calendar to the composite calendar. In response to determining that the schedule entry is to be merged from the composite calendar to the component calendar, merging 230 the schedule entry from the composite calendar to the component calendar in accordance with the first policy.

The method further includes establishing 240 the second policy to define the merging of the schedule entry from the component calendar to the composite calendar. In response to determining that the schedule entry is to be merged from the component calendar to the composite calendar, merging 250 the schedule entry from the component calendar to the composite calendar in accordance with the established second policy.

Establishing 260 the third policy defines the merging of the schedule entry from the component calendar to the other component calendar. In response to determining that the schedule entry is to be merged from the component calendar to the other component calendar, merging 270 the schedule entry from the component calendar to the other component calendar in accordance with the established third policy.

In response to determining that the conflict exists between any two schedule entries relating to the composite calendar, the component calendar, or the other component calendar, the method concludes with comparing 280 the priority levels of the two schedule entries in conflict, and merging into the composite calendar the respective schedule entry having the higher priority level.

In an embodiment, the establishing the first rule-based policy, the establishing the second rule-based policy, and the establishing the third rule-based policy may be selected from one of the following: modifying the schedule entry subsequent to the schedule entry being merged to the specific component calendar; specifying the schedule entry time criteria, and defining the merge policy to merge the schedule entry that meets the specified schedule entry time criteria; specifying the schedule entry date criteria, and defining the merge policy to merge the schedule entry that meets the specified schedule entry date criteria; and, specifying the schedule entry content criteria, and defining the merge policy to merge the schedule entry that meets the specified schedule entry content criteria.

In an embodiment, the establishing the first, second, and third rule-based policies may include any number of nested rules, such as combining various schedule criteria within the single rule-based policy, such as combining the schedule entry time criteria and the schedule entry date criteria, for example. In an embodiment, the establishing the first, second, and third rule-based policies may include any number of nested rules, such as combining more than one of the same schedule criteria within the single rule-based policy, such as combining multiple schedule entry content criteria, for example.

In an embodiment, at least one of the establishing the first policy, the establishing the second policy, and the establishing the third policy include specifying at least two of the schedule entry time criteria, the schedule entry date criteria, and the schedule entry content criteria, and defining the policy to merge the schedule entry that meets the at least two specified schedule entry criteria. In another embodiment, the merging the schedule entry from the composite calendar to the component calendar includes a single component calendar, and the merging the schedule entry from the component calendar to the composite calendar includes a single component calendar.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of merging a schedule entry between a composite calendar allowed to comprise all of a plurality of schedule entries pertaining to a user, and a component calendar comprising a portion of the plurality of schedule entries, the method comprising:
establishing and applying a priority policy based upon criteria of the schedule entry to define a priority level of the schedule entry within the composite calendar;
establishing a first policy to define the merging of the schedule entry from the composite calendar to the component calendar;
in response to determining that the schedule entry is to be merged from the composite calendar to the component calendar, merging the schedule entry from the composite calendar to the component calendar in accordance with the first policy;
establishing a second policy to define the merging of the schedule entry from the component calendar to the composite calendar;
in response to determining that the schedule entry is to be merged from the component calendar to the composite calendar, merging the schedule entry from the component calendar to the composite calendar in accordance with the established second policy;
establishing a third policy to define the merging of the schedule entry from the component calendar to another component calendar;
in response to determining that the schedule entry is to be merged from the component calendar to the other component calendar, merging the schedule entry from the component calendar to the other component calendar in accordance with the established third policy; and
in response to determining that a conflict exists between any two schedule entries relating to the composite calendar, the component calendar, or the other component calendar:
comparing the priority levels of the two schedule entries in conflict; and
merging into the composite calendar the respective schedule entry having a higher priority level.

2. The method of claim 1, wherein the establishing and applying the priority policy comprises:
assigning a specific priority level to all schedule entries merged from a specific component calendar to the composite calendar.

3. The method of claim 1, wherein at least one of the establishing the first policy and the establishing the third policy comprise:
modifying the schedule entry subsequent to the schedule entry being merged to a specific component calendar.

4. The method of claim 1, wherein at least one of the establishing the first policy, the establishing the second policy, and the establishing the third policy comprise:
specifying a schedule entry time criteria; and
defining a merge policy to merge the schedule entry that meets the specified schedule entry time criteria.

5. The method of claim 1, wherein at least one of the establishing the first policy, the establishing the second policy, and the establishing the third policy comprise:
specifying a schedule entry date criteria; and
defining a merge policy to merge the schedule entry that meets the specified schedule entry date criteria.

6. The method of claim 1, wherein at least one of the establishing the first policy, the establishing the second policy, and the establishing the third policy comprise:
specifying a schedule entry content criteria; and
defining a merge policy to merge the schedule entry that meets the specified schedule entry content criteria.

7. The method of claim 1, wherein at least one of the establishing the first policy, the establishing the second policy, and the establishing the third policy comprise:
specifying at least two of a schedule entry time criteria, a schedule entry date criteria, and a schedule entry content criteria; and
defining a merge policy to merge the schedule entry that meets the at least two specified schedule entry criteria.

8. The method of claim 1, wherein:
the merging the schedule entry from the composite calendar to the component calendar comprises a single component calendar; and
the merging the schedule entry from the component calendar to the composite calendar comprises a single component calendar.

9. A program storage device readable by a computer, the device embodying a program or instructions executable by the computer to perform the method of claim 1.

10. A system for merging a schedule entry between a composite calendar allowed to comprise all of a plurality of schedule entries pertaining to a user, and a component calendar comprising a portion of the plurality of schedule entries, the system comprising:
means for establishing and applying a priority policy based upon criteria of the schedule entry to define a priority level of the schedule entry within the composite calendar;
means for establishing a first policy to define the merging of the schedule entry from the composite calendar to the component calendar;
means for merging the schedule entry, in response to determining that the schedule entry is to be merged from the composite calendar to the component calendar, from the composite calendar to the component calendar in accordance with the first policy;
means for establishing a second policy to define the merging of the schedule entry from the component calendar to the composite calendar;
means for merging the schedule entry, in response to determining that the schedule entry is to be merged from the component calendar to the composite calendar, from the component calendar to the composite calendar in accordance with the established second policy;
means for establishing a third policy to define the merging of the schedule entry from the component calendar to another component calendar;
means for merging the schedule entry, in response to determining that the schedule entry is to be merged from the component calendar to the other component calendar, from the component calendar to the other component calendar in accordance with the established third policy;
means for comparing the priority levels, in response to determining that a conflict exists between any two schedule entries relating to the composite calendar, the component calendar, or the other component calendar, of the two schedule entries in conflict; and
means for merging, in response to determining that a conflict exists between any two schedule entries relating to the composite calendar, the component calendar, or the other component, into the composite calendar the schedule entry having the higher priority level.

11. The system of claim 10, wherein the means for establishing and applying the priority policy comprise:
means for assigning a specific priority level to all schedule entries merged from a specific component calendar to the composite calendar.

12. The system of claim 10, wherein at least one of the means for establishing the first policy and the means for establishing the third policy comprise:
means for modifying the schedule entry subsequent to the schedule entry being merged to a specific component calendar.

13. The system of claim 10, wherein at least one of the means for establishing the first policy, the means for establishing the second policy, and the means for establishing the third policy comprise:
means for specifying a schedule entry time criteria; and
means for defining a merge policy to merge the schedule entry that meets the specified schedule entry time criteria.

14. The system of claim 10, wherein at least one of the means for establishing the first policy, the means for establishing the second policy, and the means for establishing the third policy comprise:
means for specifying a schedule entry date criteria; and
means for defining a merge policy to merge the schedule entry that meets the specified schedule entry date criteria.

15. The system of claim 10, wherein at least one of the means for establishing the first policy, the means for establishing the second policy, and the means for establishing the third policy comprise:
means for specifying a schedule entry content criteria; and
means for defining a merge policy to merge the schedule entry that meets the specified schedule entry content criteria.

16. The system of claim 10, wherein at least one of the means for establishing the first policy, the means for establishing the second policy, and the means for establishing the third policy comprise:
means for specifying at least two of a schedule entry time criteria, a schedule entry date criteria, and a schedule entry content criteria; and
means for defining a merge policy to merge the schedule entry that meets the at least two specified schedule entry criteria.

17. The system of claim 10, wherein:
the means for merging the schedule entry from the composite calendar to the component calendar comprises a single component calendar; and
the means for merging the schedule entry from the component calendar to the composite calendar comprises a single component calendar.
